(19) United States
(12) Patent Application Publication
(10) Pub. No.: US 2006/0227198 A1
(43) Pub. Date: Oct. 12, 2006

(54) Electronic bow correction and registration control for a printer

(75) Inventor: Yee S. Ng, Fairport, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/102,312

(22) Filed: Apr. 8, 2005

(51) Int. Cl. B41J 2/41

(52) U.S. Cl. 347/112; 347/130

(57) ABSTRACT

An image-forming apparatus comprising an electrophotoconductive imaging member; a first charger for forming an electrostatic charge on the imaging member; a first array exposure device for imagewise modulating the electrostatic charge on an area of the member; a developer for forming a first visible image with a pigmented toner; second charger for electrostatically charging the visible image; a transfer station to transfer visible images to a receiver; and a raster image processor responsive to raster image data for controlling the array exposure device to record rasterized lines of image data in a direction transverse to the first direction including a buffer for storing data representing bow correction data in printing substantially straight raster lines of image data utilizing multiple address binary input data provided by encoder pulses derived from the position of the electrophotoconductive imaging member.

### FIELD OF THE INVENTION

This invention is in the field of digital printing, and is more specifically directed to managing the rasterization of images in a digital printing system.

### BACKGROUND OF THE INVENTION

Electrographic printing has become the prevalent technology for modem computer-driven printing of text and images, on a wide variety of hard copy media. This technology is also referred to as electrographic marking, electrostatographic printing or marking, and electrophotographic printing or marking. Conventional electrographic printers are well suited for high resolution and high speed printing, with resolutions of 600 dpi (dots per inch) and higher becoming available even at modest prices. As will be described below, at these resolutions, modern electrographic printers and copiers are well-suited to be digitally controlled and driven, and are thus highly compatible with computer graphics and imaging. Efforts regarding such printers or printing systems have led to continuing developments to improve their versatility practicality, and efficiency.

### BRIEF DESCRIPTION OF THE DRAWINGS

FIG. 1 is a schematic diagram of an electrographic marking or reproduction system in accordance with the present invention;

FIG. 2 is a schematic diagram of an electrographic marking or reproduction system in accordance with the present invention;

FIG. 3 is a schematic diagram of an electrographic marking or reproduction system in accordance with the present invention;

FIG. 4 is a is an illustration of pixel recording using X dpi times Y dpi addressability with hash lines;

FIG. 5 is an illustration of the print effects of bow in a writer array;

FIG. 6 is a flow chart for writer array bow correction according to the present invention; and

FIG. 7 is a flow chart for writer array bow correction according to the present invention.

### DETAILED DESCRIPTION

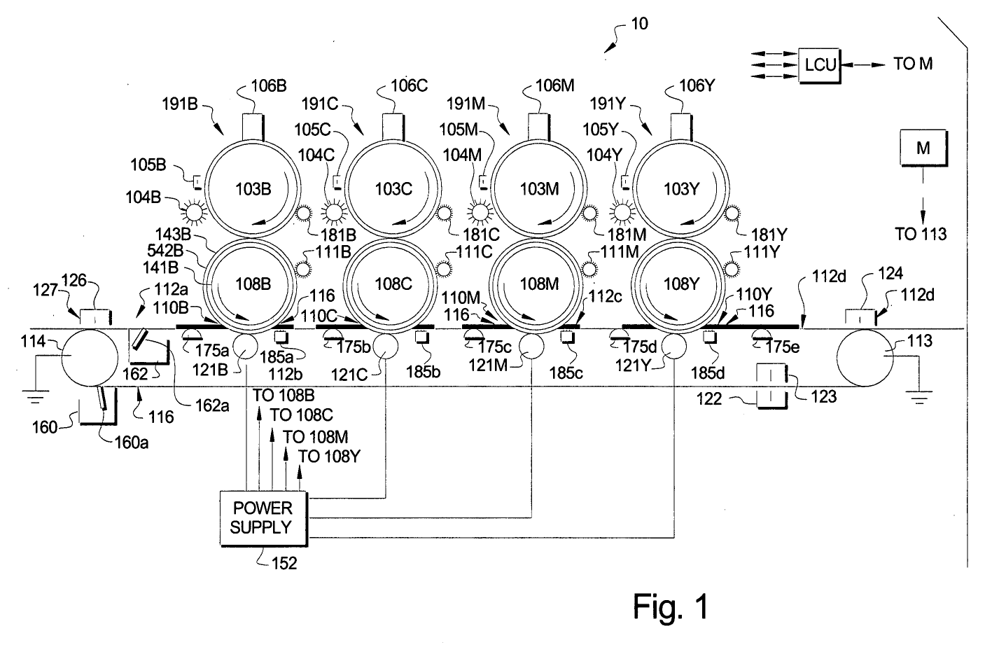

FIG. 1 shows an image forming reproduction apparatus according to another embodiment of the invention and designated generally by the numeral 10. The reproduction apparatus 10 is in the form of an electrophotographic reproduction apparatus and more particularly a color reproduction apparatus wherein color separation images are formed in each of four color modules (191B, 191C, 191M, 191Y) and transferred in register to a receiver member as a receiver member is moved through the apparatus while supported on a paper transport web (PTW) 116. More or less than four color modules may be utilized.

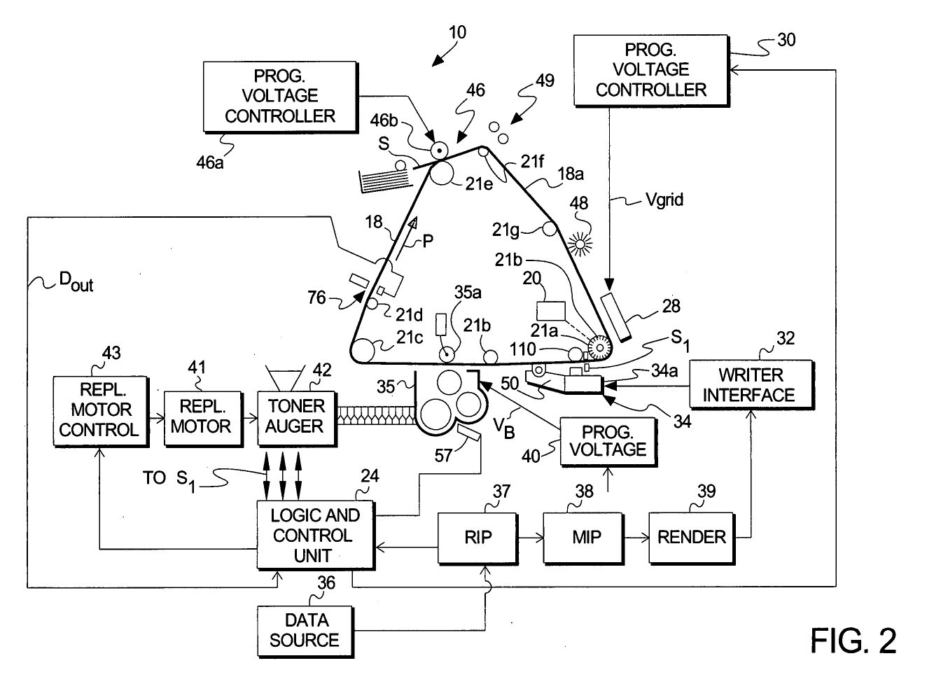

Each module is of similar construction except that as shown one paper transport web 116 which may be in the form of an endless belt operates with all the modules and the receiver member is transported by the PTW 116 from module to module. The elements in FIG. 2 that are similar from module to module have similar reference numerals with a suffix of B, C, M and Y referring to the color module to which it is associated; i.e., black, cyan, magenta and yellow, respectively. Four receiver members or sheets 112a, b, c and d are shown simultaneously receiving images from the different modules, it being understood as noted above that each receiver member may receive one color image from each module and that in this example up to four color images can be received by each receiver member. The movement of the receiver member with the PTW 116 is such that each color image transferred to the receiver member at the transfer nip of each module is a transfer that is registered with the previous color transfer so that a four-color image formed on the receiver member has the colors in registered superposed relationship on the receiver member. The receiver members are then serially detacked from the PTW and sent to a fusing station (not shown) to fuse or fix the dry toner images to the receiver member. The PTW is reconditioned for reuse by providing charge to both surfaces using, for example, opposed corona chargers 122, 123 which neutralize charge on the two surfaces of the PTW.

Each color module includes a primary image-forming member (PIFM), for example a rotating drum 103B, C, M and Y, respectively. The drums rotate in the directions shown by the arrows and about their respective axes. Each PIFM 103B, C, M and Y has a photoconductive surface, upon which a pigmented marking particle image, or a series of different color marking particle images, is formed. In order to form images, the outer surface of the PIFM is uniformly charged by a primary charger such as a corona charging device 105 B, C, M and Y, respectively or other suitable charger such as roller chargers, brush chargers, etc. The uniformly charged surface is exposed by suitable exposure means, such as for example a laser 106 B, C, M and Y, respectively or more preferably an LED or other electro-optical exposure device or even an optical exposure device to selectively alter the charge on the surface of the PIFM to create an electrostatic latent image corresponding to an image to be reproduced. The electrostatic image is developed by application of pigmented charged marking particles to the latent image bearing photoconductive drum by a development station 181 B, C, M and Y, respectively. The development station has a particular color of pigmented toner marking particles associated respectively therewith. Thus, each module creates a series of different color marking particle images on the respective photoconductive drum. In lieu of a photoconductive drum which is preferred, a photoconductive belt may be used.

Electrophotographic recording is described herein for exemplary purposes only. For example, there may be used electrographic recording of each primary color image using stylus recorders or other known recording methods for recording a toner image on a dielectric member that is to be transferred electrostatically as described herein. Broadly, the primary image is formed using electrostatography. In addition, the present invention applies to other printing systems as well, such as inkjet, thermal printing, etc.

Each marking particle image formed on a respective PIFM is transferred electrostatically to an outer surface of a respective secondary or intermediate image transfer member (ITM), for example, an intermediate transfer drum 108 B, C, M and Y, respectively. The PIFMs are each caused to rotate about their respective axes by frictional engagement with a respective ITM. The arrows in the ITMs indicate the directions of rotations. After transfer the toner image is cleaned from the surface of the photoconductive drum by a suitable cleaning device 104 B, C, M and Y, respectively to prepare the surface for reuse for forming subsequent toner images. The intermediate transfer drum or ITM preferably includes a metallic (such as aluminum) conductive core 141 B, C, M and Y, respectively and a compliant blanket layer 143 B, C, M and Y, respectively. The cores 141 C, M and Y and the blanket layers 143 C, M and Y are shown but not identified in FIG. 2 but correspond to similar structure shown and identified for module 191 B. The compliant layer is formed of an elastomer such as polyurethane or other materials well noted in the published literature. The elastomer has been doped with sufficient conductive material (such as antistatic particles, ionic conducting materials, or electrically conducting dopants) to have a relatively low resistivity. With such a relatively conductive intermediate image transfer member drum, transfer of the single color marking particle images to the surface of the ITM can be accomplished with a relatively narrow nip width and a relatively modest potential of suitable polarity applied by a constant voltage potential source (not shown). Different levels of constant voltage can be provided to the different ITMs so that the constant voltage on one ITM differs from that of another ITM in the apparatus.

A single color marking particle image respectively formed on the surface 142B (others not identified) of each intermediate image transfer member drum, is transferred to a toner image receiving surface of a receiver member, which is fed into a nip between the intermediate image transfer member drum and a transfer backing roller (TBR) 121 B, C, M and Y, respectively, that is suitably electrically biased by a constant current power supply 152 to induce the charged toner particle image to electrostatically transfer to a receiver sheet. Each TBR is provided with a respective constant current by power supply 152. The transfer backing roller or TBR preferably includes a metallic (such as aluminum) conductive core and a compliant blanket layer. Although a resistive blanket is preferred, the TBR may be a conductive roller made of aluminum or other metal. The receiver member is fed from a suitable receiver member supply (not shown) and is suitably “tacked” to the PTW 116 and moves serially into each of the nips 110, C, M and Y where it receives the respective marking particle image in suitable registered relationship to form a composite multicolor image. As is well known, the colored pigments can overlie one another to form areas of colors different from that of the pigments. The receiver member exits the last nip and is transported by a suitable transport mechanism (not shown) to a fuser where the marking particle image is fixed to the receiver member by application of heat and/or pressure and, preferably both. A detack charger 124 may be provided to deposit a neutralizing charge on the receiver member to facilitate separation of the receiver member from the belt 116. The receiver member with the fixed marking particle image is then transported to a remote location for operator retrieval. The respective ITMs are each cleaned by a respective cleaning device 111B, C, M and Y to prepare it for reuse. Although the ITM is preferred to be a drum, a belt may be used instead as an ITM.

Appropriate sensors such as mechanical, electrical, or optical sensors described hereinbefore are utilized in the reproduction apparatus 10′ to provide control signals for the apparatus. Such sensors are located along the receiver member travel path between the receiver member supply through the various nips to the fuser. Further sensors may be associated with the primary image forming member photoconductive drum, the intermediate image transfer member drum, the transfer backing member, and various image processing stations. As such, the sensors detect the location of a receiver member in its travel path, and the position of the primary image forming member photoconductive drum in relation to the image forming processing stations, and respectively produce appropriate signals indicative thereof. Such signals are fed as input information to a logic and control unit LCU including a microprocessor, for example. Based on such signals and a suitable program for the microprocessor, the control unit LCU produces signals to control the timing operation of the various electrostatographic process stations for carrying out the reproduction process and to control drive by motor M of the various drums and belts. The production of a program for a number of commercially available microprocessors, which are suitable for use with the invention, is a conventional skill well understood in the art. The particular details of any such program would, of course, depend on the architecture of the designated microprocessor.

The receiver members utilized with the reproduction apparatus 10 can vary substantially. For example, they can be thin or thick paper stock (coated or uncoated) or transparency stock. As the thickness and/or resistivity of the receiver member stock varies, the resulting change in impedance affects the electric field used in the nips 110B, C, M, Y to urge transfer of the marking particles to the receiver members. Moreover, a variation in relative humidity will vary the conductivity of a paper receiver member, which also affects the impedance and hence changes the transfer field. To overcome these problems, the paper transport belt preferably includes certain characteristics.

The endless belt or web (PTW) 116 is preferably comprised of a material having a bulk electrical resistivity. This bulk resistivity is the resistivity of at least one layer if the belt is a multilayer article. The web material may be of any of a variety of flexible materials such as a fluorinated copolymer (such as polyvinylidene fluoride), polycarbonate, polyurethane, polyethylene terephthalate, polyimides (such as Kapton™), polyethylene napthoate, or silicone rubber. Whichever material that is used, such web material may contain an additive, such as an anti-stat (e.g. metal salts) or small conductive particles (e.g. carbon), to impart the desired resistivity for the web. When materials with high resistivity are used additional corona charger(s) may be needed to discharge any residual charge remaining on the web once the receiver member has been removed. The belt may have an additional conducting layer beneath the resistive layer which is electrically biased to urge marking particle image transfer. Also acceptable is to have an arrangement without the conducting layer and instead apply the transfer bias through either one or more of the support rollers or with a corona charger. It is also envisioned that the invention applies to an electrostatographic color machine wherein a generally continuous paper web receiver is utilized and the need for a separate paper transport web is not required. Such continuous webs are usually supplied from a roll of paper that is supported to allow unwinding of the paper from the roll as the paper passes as a generally continuous sheet through the apparatus.

In feeding a receiver member onto belt 116, charge may be provided on the receiver member by charger 126 to electrostatically attract the receiver member and “tack” it to the belt 116. A blade 127 associated with the charger 126 may be provided to press the receiver member onto the belt and remove any air entrained between the receiver member and the belt.

A receiver member may be engaged at times in more than one image transfer nip and preferably is not in the fuser nip and an image transfer nip simultaneously. The path of the receiver member for serially receiving in transfer the various different color images is generally straight facilitating use with receiver members of different thicknesses.

The endless paper transport web (PTW) 116 is entrained about a plurality of support members. For example, as shown in FIG. 2, the plurality of support members are rollers 113, 114 with preferably roller 113 being driven as shown by motor M to drive the PTW (of course, other support members such as skis or bars would be suitable for use with this invention). Drive to the PTW can frictionally drive the ITMs to rotate the ITMs which in turn causes the PIFMs to be rotated, or additional drives may be provided. The process speed is determined by the velocity of the PTW.

Alternatively, direct transfer of each image may be made directly from respective photoconductive drums to the receiver sheet as the receiver sheet serially advances through the transfer stations while supported by the paper transport web without ITMs. The respective toned color separation images are transferred in registered relationship to a receiver member as the receiver member serially travels or advances from module to module receiving in transfer at each transfer nip a respective toner color separation image. Either way, different receiver sheets may be located in different nips simultaneously and at times one receiver sheet may be located in two adjacent nips simultaneously, it being appreciated that the timing of image creation and respective transfers to the receiver sheet is such that proper transfer of images are made so that respective images are transferred in register and as expected.

Referring to FIG. 2, a printer machine 10′ includes a moving exposure medium 18, such as a photoconductive belt which is entrained about a plurality of rollers or other supports 21a through 21g, one or more of which is driven by a motor to advance the belt. By way of example, roller 21a is illustrated as being driven by motor 20. Motor 20 preferably advances the belt at a high speed, such as 20 inches per second or higher, in the direction indicated by arrow P, past a series of workstations of the printer machine 10′. Alternatively, exposure medium 18 may be wrapped and secured about only a single drum.

Printer machine 10′ includes a controller or logic and control unit (LCU) 24, preferably a digital computer or microprocessor operating according to a stored program for sequentially actuating the workstations within printer machine 10′, effecting overall control of printer machine 10′ and its various subsystems. LCU 24 also is programmed to provide closed-loop control of printer machine 10′ in response to signals from various sensors and encoders. Aspects of process control are described in U.S. Pat. No. 6,121,986 incorporated herein by this reference.

A primary charging station 28 in printer machine 10′ sensitizes exposure medium 18 by applying a uniform electrostatic corona charge, from high-voltage charging wires at a predetermined primary voltage, to a surface 18a of exposure medium 18. The output of charging station 28 is regulated by a programmable voltage controller 30, which is in turn controlled by LCU 24 to adjust this primary voltage, for example by controlling the electrical potential of a grid and thus controlling movement of the corona charge. Other forms of chargers, including brush or roller chargers, may also be used.

An exposure station 34 in printer machine 10′ projects light from a writer 34a to exposure medium 18. This light selectively dissipates the electrostatic charge on photoconductive exposure medium 18 to form a latent electrostatic image of the document to be copied or printed. Writer 34a is preferably constructed as an array of light emitting diodes (LEDs), or alternatively as another light source such as a laser or spatial light modulator controlled by a writer interface controller 32. Writer 34a exposes individual picture elements (pixels) of exposure medium 18 with light at a regulated intensity and exposure, in the manner described below. The exposing light discharges selected pixel locations of the photoconductor, so that the pattern of localized voltages across the photoconductor corresponds to the image to be printed. An image is a pattern of physical light which may include characters, words, text, and other features such as graphics, photos, etc. An image may be included in a set of one or more images, such as in images of the pages of a document. An image may be divided into segments, objects, or structures each of which is itself an image. A segment, object or structure of an image may be of any size up to and including the whole image.

Image data to be printed is provided by an image data source 36, which is a device that can provide digital data defining a version of the image. Such types of devices are numerous and include computer or microcontroller, computer workstation, scanner, digital camera, etc. These data represent the location and intensity of each pixel that is exposed by the printer. Signals from data source 36, in combination with control signals from LCU 24 are provided to a raster image processor (RIP) 37. The digital images (including styled text) are converted by the RIP 37 from their form in a page description language (PDL) language and converts it into raster, which is a sequence of serial instructions in a form for the marking engine can accept (a process commonly known as “ripping”) and which provides the ripped image to a image storage and retrieval system known as a page buffer memory (PBM) 38.

The PBM functionally replaces recirculating feeders on optical copiers. This means that images are not mechanically rescanned within jobs that require rescanning, but rather, images are electronically retrieved from the PBM to replace the rescan process. The PBM accepts digital image input and stores it for a limited time so it can be retrieved and printed to complete the job as needed. The PBM consists of memory for storing digital image input received from the RIP. Once the images are in PBM, they can be repeatedly read from memory. The amount of memory required to store a given number of images can be reduced by compressing the images; therefore, the images are compressed prior to PBM memory storage, then decompressed while being read from PBM memory.

The output of the PBM is provided to an image render circuit 39, which alters the image and provides the altered image to the writer interface controller 32 which applies exposure parameters to the array writer (otherwise known as a write head, print head, etc.) to expose moving exposure medium 18.

After exposure, the portion of exposure medium 18 bearing the latent charge images travels to a development station 35. Development station 35 includes a magnetic brush in juxtaposition to the exposure medium 18. Magnetic brush development stations are well known in the art, and are preferred in many applications; alternatively, other known types of development stations or devices may be used. Plural development stations 35 may be provided for developing images in plural grey scales, colors, or from toners of different physical characteristics. Full process color electrographic printing is accomplished by utilizing this process for each of four toner colors (e.g., black, cyan, magenta, yellow).

Upon the imaged portion of exposure medium 18 reaching development station 35, LCU 24 selectively activates development station 35 to apply toner to exposure medium 18 by moving backup roller 35a to move exposure medium 18, into engagement with or close proximity to the magnetic brush. Alternatively, the magnetic brush may be moved toward exposure medium 18 to selectively engage exposure medium 18. In either case, charged toner particles on the magnetic brush are selectively attracted to the latent image patterns present on exposure medium 18, developing those image patterns. As the exposed photoconductor passes the developing station, toner is attracted to pixel locations of the photoconductor and as a result, a pattern of toner corresponding to the image to be printed appears on the photoconductor. As known in the art, conductor portions of development station 35, such as conductive applicator cylinders, are biased to act as electrodes. The electrodes are connected to a variable supply voltage, which is regulated by programmable controller 40 in response to LCU 24, by way of which the development process is controlled.

Development station 35 may contain a two component developer mix which comprises a dry mixture of toner and carrier particles. Typically the carrier preferably comprises high coercivity (hard magnetic) ferrite particles. As an example, the carrier particles have a volume-weighted diameter of approximately 30μ. The dry toner particles are substantially smaller, on the order of 6μ to 15μ in volume-weighted diameter. Development station 35 may include an applicator having a rotatable magnetic core within a shell, which also may be rotatably driven by a motor or other suitable driving means. Relative rotation of the core and shell moves the developer through a development zone in the presence of an electrical field. In the course of development, the toner selectively electrostatically adheres to photoconductive exposure medium 18 to develop the electrostatic images thereon and the carrier material remains at development station 35. As toner is depleted from the development station due to the development of the electrostatic image, additional toner is periodically introduced by toner auger 42 into development station 35 to be mixed with the carrier particles to maintain a uniform amount of development mixture. This development mixture is controlled in accordance with various development control processes. Single component developer stations, as well as conventional liquid toner development stations, may also be used.

A transfer station 46 in printing machine 10′ moves a receiver sheet S into engagement with photoconductive exposure medium 18, in registration with a developed image to transfer the developed image to receiver sheet S. Receiver sheets S may be plain or coated paper, plastic, or another medium capable of being handled by printer machine 10′. Typically, transfer station 46 includes a charging device for electrostatically biasing movement of the toner particles from exposure medium 18 to receiver sheet S. In this example, the biasing device is roller 46b, which engages the back of sheet S and which is connected to programmable voltage. controller 46a that operates in a constant current mode during transfer. Alternatively, an intermediate member may have the image transferred to it and the image may then be transferred to receiver sheet S. After transfer of the toner image to receiver sheet S, sheet S is detacked from exposure medium 18 and transported to fuser station 49 where the image is fixed onto sheet S, typically by the application of heat. Alternatively, the image may be fixed to sheet s at the time of transfer.

A cleaning station 48, such as a brush, blade, or web is also located behind transfer station 46, and removes residual toner from exposure medium 18. A pre-clean charger (not shown) may be located before or at cleaning station 48 to assist in this cleaning. After cleaning, this portion of exposure medium 18 is then ready for recharging and re-exposure. Of course, other portions of exposure medium 18 are simultaneously located at the various workstations of printing machine 10′, so that the printing process is carried out in a substantially continuous manner.

LCU 24 provides overall control of the apparatus and its various subsystems as is well known. LCU 24 will typically include temporary data storage memory, a central processing unit, timing and cycle control unit, and stored program control. Data input and output is performed sequentially through or under program control. Input data can be applied through input signal buffers to an input data processor, or through an interrupt signal processor, and include input signals from various switches, sensors, and analog-to-digital converters internal to printing machine 10′, or received from sources external to printing machine 10′, such from as a human user or a network control. The output data and control signals from LCU 24 are applied directly or through storage latches to suitable output drivers and in turn to the appropriate subsystems within printing machine 10′.

Process control strategies generally utilize various sensors to provide real-time closed-loop control of the electrostatographic process so that printing machine 10′ generates “constant” image quality output, from the user's perspective. Real-time process control is necessary in electrographic printing, to account for changes in the environmental ambient of the photographic printer, and for changes in the operating conditions of the printer that occur over time during operation (rest/run effects). An important environmental condition parameter requiring process control is relative humidity, because changes in relative humidity affect the charge-to-mass ratio q/m of toner particles. The ratio q/m directly determines the density of toner that adheres to the photoconductor during development, and thus directly affects the density of the resulting image. System changes that can occur over time include changes due to aging of the printhead (exposure station), changes in the concentration of magnetic carrier particles in the toner as the toner is depleted through use, changes in the mechanical position of primary charger elements, aging of the photoconductor, variability in the manufacture of electrical components and of the photoconductor, change in conditions as the printer warms up after power-on, triboelectric charging of the toner, and other changes in electrographic process conditions. Because of these effects and the high resolution of modem electrographic printing, the process control techniques have become quite complex.

Process control sensor may be a densitometer 76, which monitors test patches that are exposed and developed in non-image areas of photoconductive exposure medium 18 under the control of LCU 24. Densitometer 76 measures the density of the test patches, which is compared to a target density. Densitometer may include an infrared or visible light led, which either shines through the exposure medium or is reflected by the exposure medium onto a photodiode in densitometer 76. These toned test patches are exposed to varying toner density levels, including full density and various intermediate densities, so that the actual density of toner in the patch can be compared with the desired density of toner as indicated by the various control voltages and signals. These densitometer measurements are used to control primary charging voltage Vₒ, maximum exposure light intensity Eₒ, and development station electrode bias V_{b}. In addition, the process control of a toner replenishment control signal value or a toner concentration setpoint value to maintain the charge-to-mass ratio q/m at a level that avoids dusting or hollow character formation due to low toner charge, and also avoids breakdown and transfer mottle due to high toner charge for improved accuracy in the process control of printing machine 10′. The toned test patches are formed in the interframe area of exposure medium 18 so that the process control can be carried out in real time without reducing the printed output throughput. Another sensor useful for monitoring process parameters in printer machine 10′ is electrometer probe 50, mounted downstream of the corona charging station 28 relative to direction p of the movement of exposure medium 18. An example of an electrometer is described in U.S. Pat. No.; 5,956,544 incorporated herein by this reference.

Other approaches to electrographic printing process control may be utilized, such as those described in international publication number WO 02/10860 A1, and international publication number WO 02/14957 A1, both commonly assigned herewith and incorporated herein by this reference.

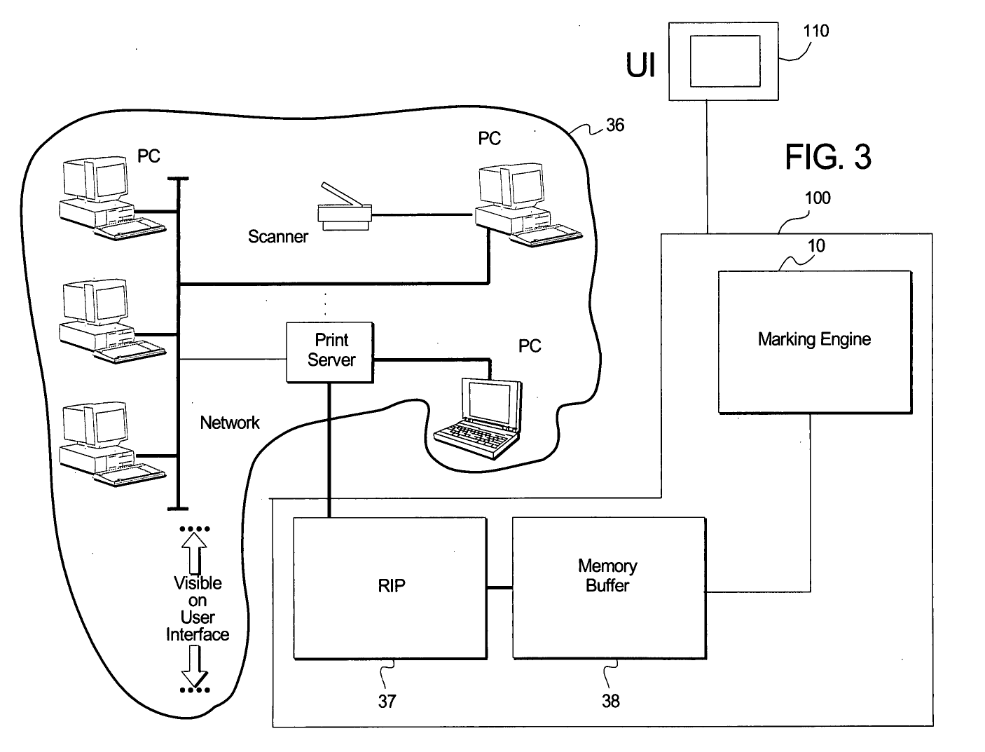

Referring to FIG. 3, image data to be printed is provided by an image data source 36, which is a device that can provide digital data defining a version of the image. Such types of devices are numerous and include computer or microcontroller, computer workstation, scanner, digital camera, etc. Multiple devices may be interconnected on a network. These image data sources are at the front end and generally include an application program that is used to create or find an image to output. The application program sends the image to a device driver, which serves as an interface between the client and the marking device. The device driver then encodes the image in a format that serves to describe what image is to be generated on a page. For instance, a suitable format is page description language (“PDL”). The device driver sends the encoded image to the marking device. This data represents the location, color, and intensity of each pixel that is exposed. Signals from data source 36, in combination with control signals from LCU 24 are provided to a raster image processor (RIP) 37 for rasterization.

In general, the major roles of the RIP 37 are to: receive job information from the server; parse the header from the print job and determine the printing and finishing requirements of the job; analyze the PDL (page description language) to reflect any job or page requirements that were not stated in the header; resolve any conflicts between the requirements of the job and the marking engine configuration (i.e., RIP time mismatch resolution); keep accounting record and error logs and provide this information to any subsystem, upon request; communicate image transfer requirements to the marking engine; translate the data from PDL (page description language) to raster for printing; and support diagnostics communication between user applications. The RIP accepts a print job in the form of a page description language (PDL) such as postscript, PDF or PCL and converts it into raster, or grid of lines or form that the marking engine can accept. The PDL file received at the RIP describes the layout of the document as it was created on the host computer used by the customer. This conversion process is also called rasterization as well as ripping. The RIP makes the decision on how to process the document based on what PDL the document is described in. It reaches this decision by looking at the beginning data of the document, or document header.

Raster image processing or ripping begins with a page description generated by the computer application used to produce the desired image. The raster image processor interprets this page description into a display list of objects. This display list contains a descriptor for each text and non-text object to be printed; in the case of text, the descriptor specifies each text character, its font, and its location on the page. For example, the contents of a word processing document with styled text is translated by the RIP into serial printer instructions that include, for the example of a binary black printer, a bit for each pixel location indicating whether that pixel is to be black or white. Binary print means an image is converted to a digital array of pixels, each pixel having a value assigned to it, and wherein the digital value of every pixel is represented by only two possible numbers, either a one or a zero. The digital image in such a case is known as a binary image. Multi-bit images, alternatively, are represented by a digital array of pixels, wherein the pixels have assigned values of more than two number possibilities. The RIP renders the display list into a “contone” (continuous tone) byte map for the page to be printed. This contone byte map represents each pixel location on the page to be printed by a density level (typically eight bits, or one byte, for a byte map rendering) for each color to be printed. Black text is generally represented by a full density value (255, for an eight bit rendering) for each pixel within the character. The byte map typically contains more information than can be used by the printer. Finally, the RIP rasterizes the byte map into a bit map for use by the printer. Halftone densities are formed by the application of a halftone “screen”to the byte map, especially in the case of image objects to be printed. Pre-press adjustments can include the selection of the particular halftone screens to be applied, for example to adjust the contrast of the resulting image.

Electrographic printers with gray scale printheads are also known, as described in international publication number WO 01/89194 A2, incorporated herein by this reference. The ripping algorithm groups adjacent pixels into sets of adjacent cells, each cell corresponding to a halftone dot of the image to be printed. The gray tones are printed by increasing the level of exposure of each pixel in the cell, by increasing the duration by way of which a corresponding led in the printhead is kept on, and by “growing”the exposure into adjacent pixels within the cell.

The digital print system quantizes images both spatially and tonally. A two dimensional image is represented by an array of discrete picture elements or pixels, and the color of each pixel is in turn represented by a plurality of discrete tone or shade values (usually an integer between 0 and 255) which correspond to the color components of the pixel: either a set of red, green and blue (RGB) values, or a set of yellow, magenta, cyan, and black (YMCK) values that will be used to control the amount of ink used by a printer.

Once the document has been ripped by one of the interpreters, the raster data goes to a page buffer memory (PBM) 38 or cache via a data bus. The PBM eventually sends the ripped print job information to the marking engine 10′. The PBM functionally replaces recirculating feeders on optical copiers. This means that images are not mechanically rescanned within jobs that require rescanning, but rather, images are electronically retrieved from the PBM to replace the rescan process. The PBM accepts digital image input and stores it for a limited time so it can be retrieved and printed to complete the job as needed. The PBM consists of memory for storing digital image input received from the rip. Once the images are in memory, they can be repeatedly read from memory and output to the print engine. The amount of memory required to store a given number of images can be reduced by compressing the images; therefore, the images may be compressed prior to memory storage, then decompressed while being read from memory. RIP 37, memory buffer 38, render circuit 39 and marking engine 10′ may all be provided in single mainframe 100, having a local user interface 110 (UI) for operating the system from close proximity.

As described hereinbefore, the RIP provides image data to a render circuit 39. The RIP 37, PBM 38 and render circuit 39 can be dedicated hardware, or a software routine such as a printer driver, or some combination of both, for accomplishing this task. The ripped data is provided to a writer driving controller As an example, array writers 34a are comprised of a line of exposure elements such as LEDs each with a respective integrated circuit driver chips located on opposite sides of the line of LEDs both of which are formed on semiconductor integrated circuit chip arrays accurately aligned in a row. In manufacturing the writers and mounting the writers, difficulty is encountered in having these LED arrays aligned properly relative to each other (in-track bow) and to the exposure medium (cross-track bow) and it is to this problem and the problem of the relative displacement of the images of the LEDs that the invention is addressed.

With reference FIG. 2, the ripped data on line Rᵢₙ is synchronized for operation by the marking engines logic and control unit (LCU) 231 which receives signals relative to movement of the photoconductor from an encoder device, as is well known. The array writers tend to vary in uniformity of light output due to differences between the LEDs resulting from their fabrication, differences in their driver currents and differences in how light is imaged by respective Selfoc lens elements.

Also, output are a series of exposure clock pulses for controlling the respective exposure during each of these exposure periods for a respective three pixel recording periods occurring during each raster line period defined in this example as 1/600 inches (4.23×10⁻² mm) of movement of the photoconductor where the LEDs are spaced 600 dots to the inch (23.62 dots to the mm) to provide a 600×600 dots per inch squared recording resolution. Generally, where a plurality of recording elements are provided and arranged in a row for recording a rasterized line of image data, the number N of recording elements per unit dimension determines a recording resolution of N×N dots per square unit dimension. Thus, there are N regular raster lines per unit dimension. Sub-raster printing relates to printing between regular raster lines.

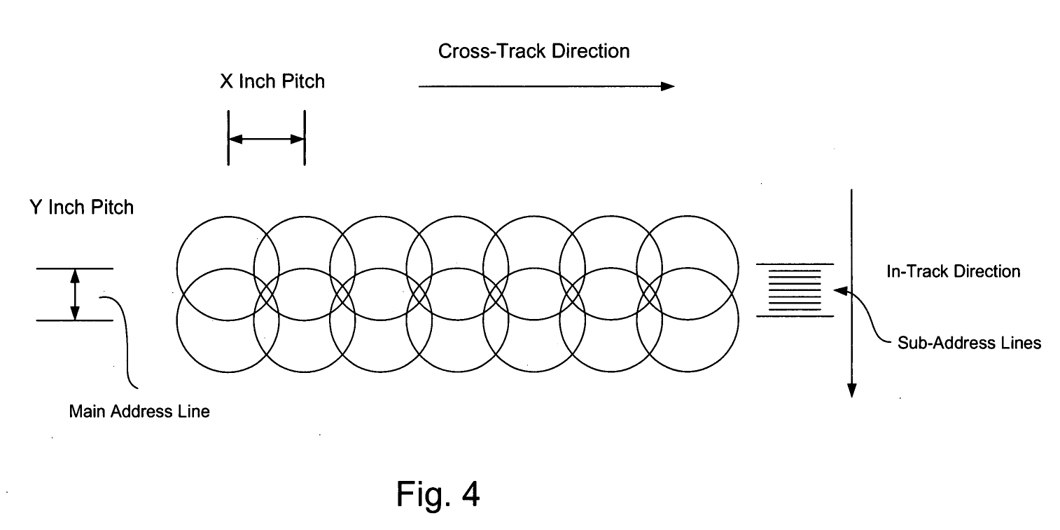

Multiple addressability of printing is described with reference to FIG. 4. Reference is hereby made to U.S. Pat. No. 5,585,836, U.S. Pat. No. 4,835,551 and U.S. Pat. No. 5,025,322 which are hereby incorporated by reference. As may be seen in FIG. 4, the recorded picture elements (pixels) are relatively large and some overlapping between adjacent lines of pixels (in-track) as well as adjacent pixels in the cross-track direction may occur. The concept of multiple addressability is to provide for increased resolution in printing by printing additional lines of data so that in the example of a 1200 dot per inch cross track printer, 4800 lines of pixels may be printed in the in-track direction. This provides a higher resolution whose image quality may be enhanced even further by providing multi-level recording or grey level recording to the formation of each pixel. The additional lines of recording are illustrated by the short hash lines in FIG. 4. Each address line represents the printing of a new line of data that is sent to the printhead.

Array Writers (or printheads), such as those in FIG. 1, 34a, 106 B, C, M and Y typically have length variation (cross-track) and bow (in-track) variations that may create color-to-color registration problems, which is especially pronounced with color printing with color printers having multiple writers. The exposure steps taught hereinbefore are carried out using separate LED (light-emitting diode) printheads for each color to be formed. Typically, these printheads have an array (such as a single row) of several thousand exposure elements, such as LEDs arranged at 1200 or more dots per inch across the photoconductor and are controllably illuminated to modulate an electrostatic charge on the photoconductor to form images on a dot-by-dot or pixel-by-pixel basis.

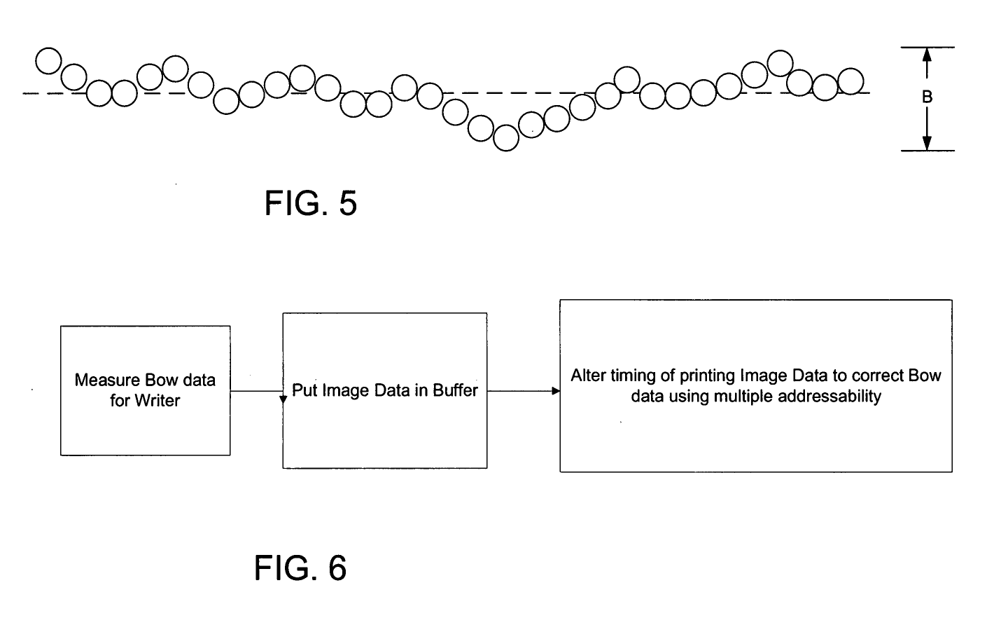

FIG. 5 illustrates how bow B writes on a non-moving substrate.

With a high addressability binary writer system, it is desirable to reduce registration problems in addition to getting more levels in a binary halftone. For example, a 1200×2400 dpi system with 1200 dpi LED writer can be used to correct for opto-mechanical bow and cross-track positioning errors between writers (from a color to color registration viewpoint) by electronically re-arranging the digital data (at a sub-pixel basis such as 1200 dpi in the cross-track direction and 2400 dpi in the in-track direction) with multiple addressability. This may improve quality down to the sub-pixel level.

Referring to FIG. 6, a flowchart in accordance with the present invention begins with measurement of the amount of bow found in each picture element, or LED in a step 220. The bow data is put into a table or buffer in a step 224. The measured bow data is then utilized, during printing, to alter the timing of excitation of the LEDs utilizing multiple addressability methodology to correct for the measured bow in a step 228.

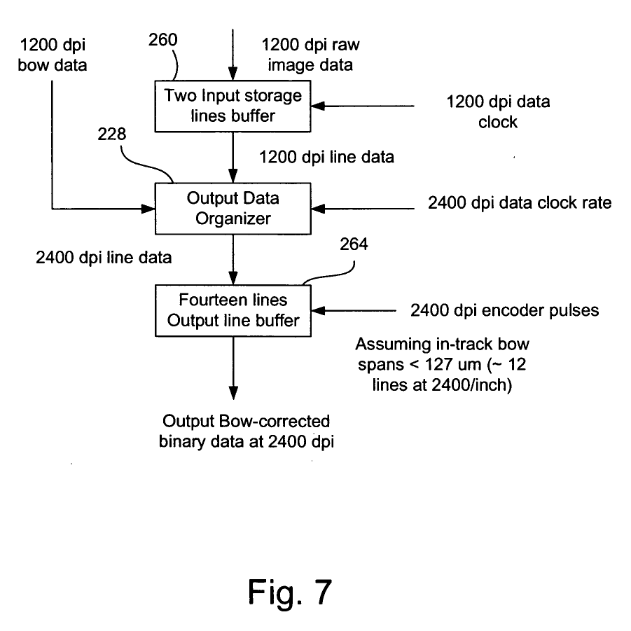

Referring now to FIG. 7, a method to reduce writer or printhead bow in the in-track direction in accordance with the present invention is shown.

For exemplary purposes, a 1200×2400 dpi binary system is described, but the present invention applies to other resolutions, as well. In a step 260, the original 1200 dpi raw image data is loaded into a buffer, such as a two-line ping-pong input buffer with the 1200 dpi data clock. The 1200 dpi line data is feed to an output data organizer, such as step 228 of FIG. 6. The data organizer has pre-stored the 1200 dpi bow data for each of the 1200 dpi pixels for the whole writer.

Assuming that the in-track bow span <127 um for all the potential writers used and in-track bow correction needed is approximately 1/2400 inch or 10.5 μm, then a potential of 12 storage lines are needed for 2400 dpi per line output in order to straighten out the bow using the pixel bow data provided. For example, a pixel location is originally bowed forward (in the in-track direction). To correct for this, that pixel's printing data is put into later lines (in other words time delayed in printing from its original time). For pixel locations originally bowed backwards, the pixel's printing data is put into earlier lines (in other words moved to time forward from it's original position). The center position of the pixel line (from a timing viewpoint) is then between the sixth and seventh buffer line in a 12 line buffer system. The result is after printing, the bowed LED imaging pixels will be effectively straightened out to within 10.5 μm in the in-track direction. The clocking of the organizer is provided utilizing a 2400 dpi data clock rate. Once the 12 data lines in the output line buffer block are filled in a pre-load condition, the pipeline can move forward (the next 1200 dpi data will start loading) in a step 264. When the next 1200 dpi of image data arrives, it will start to fill out output data lines 2 through 14, centered at between output buffer lines eight and ten in the 14 line buffer system. The data for the 2nd 1200 dpi raw data may span the output line buffer from lines 3 through 14. At the same time output line number 1 can be output for printing, clocked by 2400 dpi encoder pulses as trigger for exposure and line load start utilizing a 2400 dpi data clock. This output is the bow-corrected binary data for the 1st input raw data line at 2400 dpi in the in-track direction using multiple addressability printing concept. Once two of the fourteen output lines are printed, the system is advanced to the next 1200 dpi image data load and the process is repeated. For this example, the data line buffers are assumed to be a FIFO and operate like a barrel shifter.

Length variations (cross-track variations) between different writers (for different colors) can be compensated for by rescaling the width of the image to within one pixel (˜21 um in a 1200 dpi system) and/or shifting image (i.e. the color separations) with respect to the center of a reference (for instance the black writer).

The present invention provides a multiple address binary printing method (1200×2400×1bit) which is to be noted is not a multiple address gray level printing method. The present invention relies on a high resolution (such as a 1200 dpi system) to go beyond the visual raggedness visually detectable limit as described in J. R. Hamerly, R. M. Springer, “Raggedness of Edges”, J. Opt. Soc. Am, Vol. 71, No. 3 1981, pp 285-288. Both in-track and cross-track direction corrections can be made.

It is to be noted that the encoder pulses used to address the 1200×2400 dpi system (in the 2400 dpi direction) are actual encoder pulses based on the position of the image on the PIFM.

It is also to be noted that the image data going to the 1200×2400 dpi system (including binary halftones) are real data at the 2400 dpi level. So even though the bow correction information is used to modify the 1200×2400 dpi data before it is sent to the printhead, all the data at the 2400 dpi addressability levels are real (i.e. position correction for bow correction and reduction of edge raggedness). Since the data is real, it has to be acquired or transmitted from the RIP, and re-transmission is not appropriate and there are no sub-address pulses.

The image rescaling of the present invention may be accomplished in a number of ways, such as with a DFE (Digital Front End) or via hardware scaling wherein the output rescaled data serves as the data for the 1200 dpi raw image data. Alternatively, it may be accomplished by the image rendering circuit 39, which is post RIP data processing. In furtherance of the present invention, the LED Writer's brightness/lens transmission variations (in a per pixel basis) have been corrected by typical current trimming at the pixel level.

The present invention may be used in any type of digital printing system, such as electrostatographic, electrophotographic, inkjet, laser jet, etc. of any size or capacity in which pixel exposure adjustment value is selected prior to printing.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

It should be understood that the programs, processes, methods and apparatus described herein are not related or limited to any particular type of computer or network apparatus (hardware or software), unless indicated otherwise. Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more, fewer or other elements may be used in the block diagrams.

The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

### PARTS LIST

10 reproduction apparatus
10′ reproduction apparatus
18 exposure medium
18a surface
20 motor
21a-21g supports
24 logic and control unit
28 primary charging station
30 voltage controller
32 writer interface controller
34 exposure station
34a writer
35 development station
35a roller
36 image data source
37 raster image processor
38 page buffer memory
39 image render circuit
40 programmable controller
42 toner auger
46 transfer station
46a programmable voltage controller
46b roller
48 cleaning station
49 fuser station
50 electrometer probe
76 densitometer
100 mainframe
103B, C, M, Y rotating drum
104B, C, M, Y cleaning device
105 B, C, M, Y corona charging device
106 B, C, M, Y laser
108 B, C, M, Y intermediate transfer drum
110 user interface
110B,C,M,Y nips
111 B, C, M, Y cleaning device
112a-dreceiver members
113 roller
114 roller
116 paper transport web
121 B, C, M, Y transfer backing roller
122 corona charger
123 corona charger
124 detack charger
126 charger
127 blade
141 B, C, M, Y conductive core
142b surface
143 B, C, M, Y compliant blanket
152 power supply
181 B, C, M, Y development station
191 B, C, M, Y color modules
224 step
228 step
231 marking engines logic and control unit
264 step
B bow
M motor
N number
P arrow
S receiver sheet

What is claimed is:

1. An image-forming apparatus comprising:
an electrophotoconductive imaging member moving in a first direction;
a first charger for forming an electrostatic charge on the imaging member;
a first array exposure device for imagewise modulating the electrostatic charge on an area of the member comprising an image frame;
a developer for forming a first visible image on the image frame with a pigmented toner;
second charger for electrostatically charging the image frame having the visible image;
a transfer station to transfer visible images to a surface of a receiver; and
a raster image processor for controlling the array exposure device to record rasterized lines of image data in a direction transverse to the first direction, the raster image processor including a buffer for storing data representing bow correction data in printing of a raster line and the raster image processor is responsive to raster image data and bow correction data for recording substantially straight raster lines of image data utilizing multiple address binary input data provided by encoder pulses derived from the position of the electrophotoconductive imaging member.

2. The image-forming apparatus of claim 1, and wherein the array exposure device is comprised of light-emitting diodes.

3. The image-forming apparatus of claim 1, further comprising:
a third charger for forming an electrostatic charge on the imaging member;
a second array exposure device for imagewise modulating the electrostatic charge on an area of the member comprising an image frame;
a second developer for forming a first visible image on the image frame with a pigmented toner;
a fourth charger for electrostatically charging the image frame having the visible image;
a second transfer station to transfer visible images to a surface of a receiver; and
wherein the raster image processor also controls the second array exposure device to record rasterized lines of second image data in a direction transverse to the first direction responsive to raster image data and bow correction data for recording substantially straight raster lines of second image data utilizing multiple address binary input data provided by encoder pulses derived from the position of the electrophotoconductive imaging member.

4. The image-forming apparatus of claim 1, wherein the raster image processor further comprising controlling cross-track variations between the first and second array exposure devices are controlled by rescaling the width of the image.

5. The image-forming apparatus of claim 4, wherein the raster image processor further comprising controlling cross-track variations between the first and second array exposure devices are controlled by shifting the image.

6. A method of printing comprising:
charging an electrophotoconductive imaging member moving in a first direction with a first electrostatic charge;
modulating the first electrostatic charge on an area of the electrophotoconductive imaging member in the first direction;
forming a first visible image on the image frame with a pigmented toner;
charging the electrophotoconductive imaging member on the image frame having the visible image with a second electrostatic charge;
transferring the first visible image to a surface of a receive; and
controlling the modulation to record rasterized lines of image data in a direction transverse to the first direction by storing data representing bow correction data in printing of a raster line and being responsive to the raster image data and bow correction data for recording substantially straight raster lines of image data utilizing multiple address binary input data provided by encoder pulses derived from the position of the electrophotoconductive imaging member.

7. The method of claim 6, and wherein exposing performed with light-emitting diodes.

8. The method of claim 6, further comprising:
charging an electrophotoconductive imaging member moving in a first direction with a third electrostatic charge;
modulating the third electrostatic charge on an area of the electrophotoconductive imaging member in the first direction;
forming a second visible image on the image frame with a pigmented toner;
charging the electrophotoconductive imaging member on the image frame having the second visible image with a fourth electrostatic charge;
transferring the second visible image to a surface of a receiver; and
controlling the modulation to record rasterized lines of second image data in a direction transverse to the first direction by storing data representing bow correction data in printing of a raster line and being responsive to the raster image data and bow correction data for recording substantially straight raster lines of second image data utilizing multiple address binary input data provided by encoder pulses derived from the position of the electrophotoconductive imaging member.

9. The method of claim 6, wherein the controlling comprises controlling cross-track variations between the first and second array exposure devices are controlled by rescaling the width of the image.

10. The method of claim 6, wherein the controlling comprises controlling cross-track variations between the first and second array exposure devices are controlled by shifting the image.

11. An image-forming apparatus comprising:
a first array inkjet printhead for depositing a first visible image on the image frame of a receiver with a pigmented toner;
a raster image processor for controlling the array inkjet printhead to record rasterized lines of image data in a direction transverse to the first direction, the raster image processor including a buffer for storing data representing bow correction data in printing of a raster line and the raster image processor is responsive to raster image data and bow correction data for recording substantially straight raster lines of image data utilizing multiple address binary input data provided by encoder pulses derived from the position of the receiver.

12. The image-forming apparatus of claim 11, further comprising:
a second array inkjet printhead for depositing a first visible image on the image frame of a receiver with a pigmented toner;
wherein the raster image processor also controls the second array inkjet printhead to record rasterized lines of second image data in a direction transverse to the first direction responsive to raster image data and bow correction data for recording substantially straight raster lines of second image data utilizing multiple address binary input data provided by encoder pulses derived from the position of the receiver.

13. The image-forming apparatus of claim 11, wherein the raster image processor further comprising controlling cross-track variations between the first and second array exposure devices are controlled by rescaling the width of the image.

14. The image-forming apparatus of claim 11, wherein the raster image processor further comprising controlling cross-track variations between the first and second array inkjet printheads are controlled by shifting the image.

15. A method of printing comprising:
depositing a first visible image with pigmented toner on the image frame of a receiver utilizing a first array inkjet printhead;
controlling the depositing to record rasterized lines of image data in a direction transverse to the first direction by storing data representing bow correction data in printing of a raster line and being responsive to the raster image data and bow correction data for recording substantially straight raster lines of image data utilizing multiple address binary input data provided by encoder pulses derived from the position of the first array inkjet printhead.

16. The method of claim 15, further comprising:
depositing a second visible image with pigmented toner on the image frame of a receiver utilizing a second array inkjet printhead;
controlling the depositing to record rasterized lines of image data in a direction transverse to the first direction by storing data representing bow correction data in printing of a raster line and being responsive to the raster image data and bow correction data for recording substantially straight raster lines of image data utilizing multiple address binary input data provided by encoder pulses derived from the position of the second array inkjet printhead.

17. The method of claim 16, wherein the controlling comprises controlling cross-track variations between the first and second array exposure devices are controlled by resealing the width of the image.

18. The method of claim 16, wherein the controlling comprises controlling cross-track variations between the first and second array exposure devices are controlled by shifting the width of the image.
